(19) United States
(12) Patent Application Publication
(10) Pub. No.: US 2011/0191231 A1
(43) Pub. Date: Aug. 4, 2011

(54) Method and System for Improving Trading and a Trader's Ranking

(76) Inventor: Kenneth Ray Zuver, JR., Portland, OR (US)

(21) Appl. No.: 13/007,527

(22) Filed: Jan. 14, 2011

Related U.S. Application Data
(60) Provisional application No. 61/299,926, filed on Jan. 29, 2010.

(51) Int. Cl. G06Q 40/00

(52) U.S. Cl. 705/37

(57) ABSTRACT

A method and system are disclosed for improving trading and a trading client's rankings in a platform exchange of member clients. The method includes assigning a credit exchange rate to website performance metrics such as Google Page Rank and Alexa Rank. The broker maintains an ordered database of all clients' website backlink credit accounts where the highest account is ordered most significantly for distribution to members. Templates created by a client include a desired reference URL, desired anchor text for the link, and a description. A client may pull a backlink template within a predetermined category or class based on the highest qualifying account and posts a link to another client's website based on the link template. The client earns credits for posting a link to another member's website based on his page rank and pays credits to other members posting links to his website based on their page rank.

### CROSS-REFERENCE TO RELATED APPLICATION

This application claims the benefit of the priority date of earlier filed U.S. Provisional Patent Application Ser. No. 61/299,926, filed Jan. 29, 2010 titled, Method and System for Improving Search Engine Rankings, incorporated herein by reference in its entirety.

### BACKGROUND OF THE INVENTION

Search engine rankings are critical to online business. A search engine ranking may determine a websites' position in a buyer's search results and therefore is directly related to the number of online customers a business may attract. Page Rank was developed by and named after Larry Page who along with Sergey Brin founded Google in 1996. It is a value from 0 to 10 which is computed using a sophisticated mathematical formula that measures different factors to determine the importance of a page relative to the rest of the web. The Google Page Rank is a major factor in determining the order in which a search displays hitting websites. Therefore, web services exist for improving Google Page Rankings which trade a single link for another single link.

Search engines often use the number of backlinks that a website has as one of the most important factors for determining that website's search engine ranking. Backlinks are commonly known as incoming links or links posted by someone else linking their website to another's website. For instance, Google® describes their Page Rank system as interpreting a link from page A to page B as a vote, by page A, for page B.

There are several factors that determine the value of a backlink. Backlinks from authoritative sites on a given topic are highly valuable. If both sites have content geared toward a common keyword topic, the backlink is considered relevant and believed to have strong influence on the search engine rankings of the webpage granted the backlink. Therefore, a backlink represents a favorable ‘editorial vote’ for the receiving webpage from another granting (POSTING) webpage. Another important factor is the anchor text of the backlink. Anchor text is the descriptive labeling of the hyperlink as it appears on a webpage. Search engine bots (i.e., spiders, crawlers, etc.) examine the anchor text to evaluate how relevant it is to the content on a webpage. Anchor text and webpage content congruency are highly weighted in search engine results page (SERP) rankings of a webpage with respect to any given keyword query by a search engine user.

As a result, webmasters have devised ingenious ways to attract links back to their websites. One of these is the link exchange. A traditional link exchange is composed of a group of member webmasters who trade reciprocal (two way) links one for one using manual techniques. There are one way link exchanges on the market and even ‘automated’ one way exchanges. Regardless of the exchange configuration, most fail to produce any equitable and economical results for a website owner to improve his or her search engine ranking.

### SUMMARY OF THE INVENTION

A method is disclosed for improving trading volume and a trading member's search engine website rankings through a membership of platform exchange client members and a link broker. The method includes the broker assigning a credit exchange rate to website performance metrics. A performance metric may include a Google Page Rank, Alexa Rank or some other third party measurement. The broker credits and debits backlink credits to a client member's website account based on the client's backlink posting activity and the client's website ranking. The broker also maintains an ordered database of each member's website backlink credit accounts where the highest ranking account is ordered most significantly. Member's accounts further include backlink templates generated by each client member. The backlink templates may include a desired reference URL, a desired anchor text to be associated with the link, and a description of the reference URL.

The client pulls a highest qualifying backlink template from the broker and posts the backlink to his website based on the highest qualifying link template. The client always earns and is awarded backlink credits for posting a backlink to another member's website based on the client's page rank. A client member will always pay credits to other members who post backlinks to his website. The performance based exchange rate encourages lower ranked webmasters to post more one-way links in order to afford getting linked from higher ranked websites. However, the disclosed method also comprises one-to-one exchanges between equally ranked member clients.

An embodiment of the client membership and link broker system is configured to improve a client's search engine website rankings as disclosed. The system includes a client's backlink credit account and backlink template database, the credit account configured to keep a website account balance and the database configured to store backlink templates and other information as detailed below. An arithmetic logic module, a query logic module, an order module, a blacklisting module and a client and broker interface are also included in the system.

The query logic module is configured to query the database and perform logic functions on the resulting queries. The order module is configured to list accounts in descending order. The blacklisting module is configured to store URL addresses of blacklisters and blacklistees as chosen by clients. The client interface is configured to convey a client's net link value and link information from the broker to the client. The broker interface is configured to allow the broker to set exchange rates for backlink credits and configured to allow the broker to manage the client accounts database.

Embodiments of the disclosure also include a computer program product comprising a computer readable medium having computer useable program code. The program code is executable to perform operations for improving a client's search engine website rankings through a membership of platform exchange or trading clients. The operations of the computer program product include assigning a credit exchange rate to a set of website performance metrics, a higher credit exchange rate going to a higher performing website and a lower credit exchange rate going to a lower performing website. The operations of the computer program product also include increasing a number of one-way links to the client's website from a plurality of lower performing websites in exchange for credits from the client's higher performing website. The operations of the computer program product also comprise increasing a number of one-way links to the client's website from some higher performing websites in exchange for credits from the client and other member clients' lower performing websites. However, the computer program product also comprises one-to-one trading of one-way links between equally ranked client members.

The disclosed method may therefore incentivize and transform client member trading into higher trading volume for a variety of applications and may also improve client member rankings in an exchange platform such as the internet where member websites are ranked by third parties. Therefore, the disclosed method and system may be applied to an advertising exchange or to an internet traffic exchange or to any other exchange, trade or barter system. The aforementioned transformation is realized through a computerized system on the world-wide-web through software code implemented on the computerized system.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a flow chart of a method for improving trading and a trader's ranking in accordance with an embodiment of the present disclosure.

FIG. 2 depicts a flow chart of a method for improving link trading and a website's ranking in accordance with an embodiment of the present disclosure.

FIG. 3 depicts a flow chart of a method for improving trade and a client's search engine website rankings through a membership of clients and a link broker in accordance with an embodiment of the present disclosure.

FIG. 4 depicts an ordering algorithm which provides the highest qualifying backlink template to the client in accordance with an embodiment of the present disclosure.

FIG. 5 depicts link trading between a page rank 6 website client and 6 other member websites of various page ranks in accordance with an embodiment of the present disclosure.

FIG. 6 depicts a flow chart of a computer program product for improving a client's search engine rankings through a member exchange platform in accordance with an embodiment of the present disclosure.

FIG. 7 depicts a block diagram of the system for improving search engine rankings in accordance with an embodiment of the present disclosure.

FIG. 8 depicts a client's ‘Dashboard’ computer screen in accordance with an embodiment of the present disclosure.

FIG. 9 depicts a client's ‘New Backlink Template’ computer screen in accordance with an embodiment of the present disclosure.

FIG. 10 depicts a client's ‘Outbound, Post Another Link’ computer screen in accordance with an embodiment of the present disclosure.

Throughout the description, similar reference numbers may be used to identify similar elements.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

MONOPOLINKS™ is a link exchange network which, as an embodiment of the disclosure, provides an automated platform through which member webmasters can systematically attract one-way links back to their websites (Throughout the disclosure, the terms member, client member, member client and member webmaster are interchangeable). The embodied system and method enables members to trade one-way links based on a disclosed Google Page Rank (GPR) exchange rate. One-way links carry the most weight for Page Rank (PR) because they appear to be a natural vote for a website's content versus a reciprocal exchange where the poster and a postee both get votes or credits for a link from an anchor website to a source website.

The disclosed method and system is based on an ‘exchange rate’ which weighs websites according to their perceived quality or traffic and/or popularity and any other characteristics as determined by the broker or administrator. In the following example, the GPR is used but other search engine rankings may also be used just as easily. For instance, other embodiments may use an Alexa Rank or some other website ranking metric. The exchange rate value for each successive rank below is worth double the preceding rank.

Page Rank (PR), Exchange Value
0, 1
1, 2
2, 4
3, 8
4, 16
5, 32
6, 64
7, 128
8, 256
9, 512
10, 1024

Referring to the chart above, a single link from a PR 4 website is worth 2 links from a PR 3 website and a PR 5 link is worth two PR 4 links. This formula is one factor for MONOPOLINKS'™ popularity and success in the link exchange market. All other traditional exchanges are based on a one to one rank to exchange rate value. One to one exchange rates do not encourage link exchanges because high PR sites are reluctant to trade one for one with low PR sites. The high PR webmaster members at MONOPOLINKS™ are eager to trade with low PR sites because they get at least twice as many links for every one they post. In addition, low PR sites are eager to give multiple links in exchange for a single link from a high PR site because it boosts their website ranking with Google and other search engines. The relationship is symbiotic and mutually beneficial to both the high ranking websites and the lower ranking websites. MONOPOLINKS™ has thus achieved commercial success in the marketplace where others are failing to attract new clients and failing to retain present clients. However, the disclosed method and system will trade links on a one-to-one basis between equally ranked member clients.

The MONOPOLINKS™ one-way link distribution system is therefore an integrated and fully automated environment that allows its membership to earn one-way backlinks to their websites by posting links to other member's sites. As an embodiment of the disclosure, it is built on a computerized platform that automates many of the mundane tasks of link building and fosters an environment of confidence and prolific link distribution.

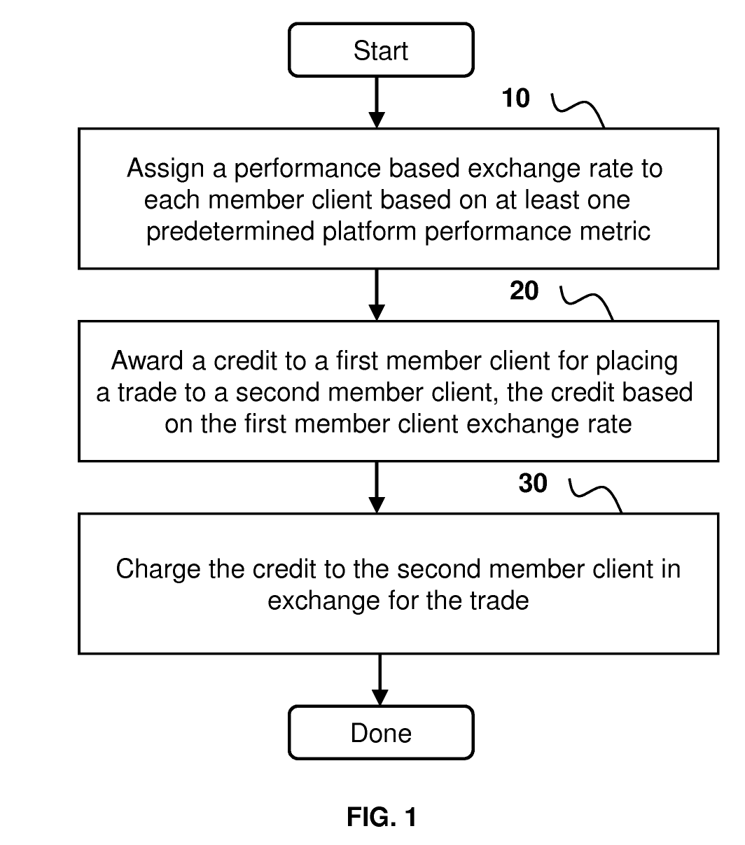

FIG. 1 depicts a flow chart of a method for improving trading and a trader's ranking in accordance with an embodiment of the present disclosure. The disclosed method includes assigning 10 a performance based exchange rate to each member client based on at least one predetermined platform performance metric. The method also includes awarding 20 a credit to a first member client for placing a trade to a second member client, the credit based on the first member client exchange rate. The method additionally includes charging 30 the credit to the second member client in exchange for the trade.

An embodiment of the disclosed method includes the first member client placing a one-way link on a webpage of the first member client pointing to a webpage of the second member client in exchange for a credit from the second member client.

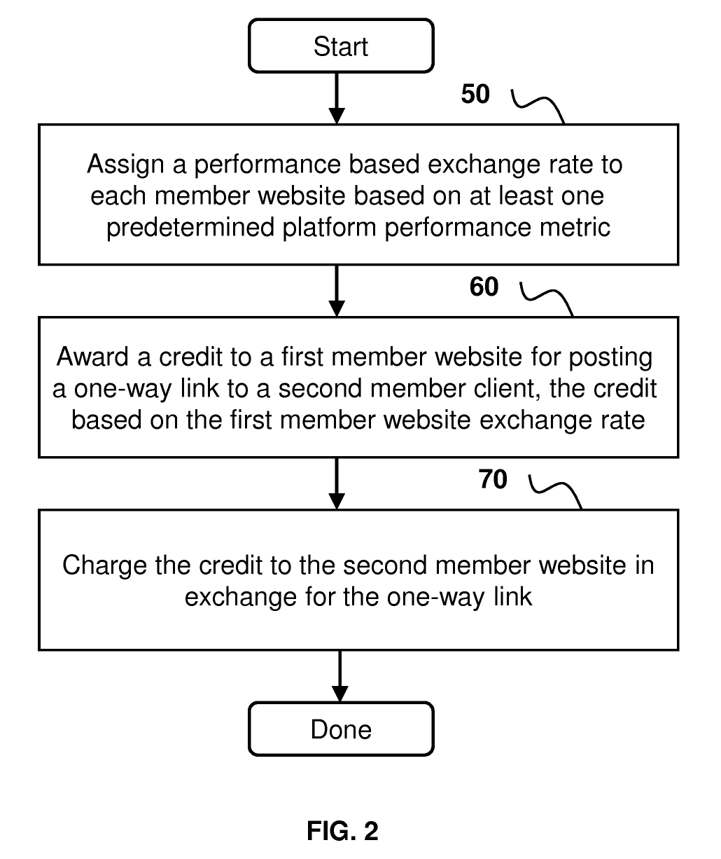

FIG. 2 depicts a flow chart of a method for improving link trading and a website's ranking in accordance with an embodiment of the present disclosure. The method comprises assigning 50 a performance based exchange rate to each member website based on at least one predetermined platform performance metric. The method also includes awarding 60 a credit to a first member website for posting a one-way link to a second member website, the credit based on the first member website exchange rate. The method additionally includes charging 70 the credit to the second member website in exchange for the one-way link.

A further embodiment of the disclosed method includes tracking member data, selecting a plurality of members based on the member data and distributing automatically a plurality of one-way link addresses to the selected members. One-way link addresses may also be randomly distributed based on the member link trading history and link trading relationships. Member data may include, among other things, a link trading history of link trading relationship between client members and client websites.

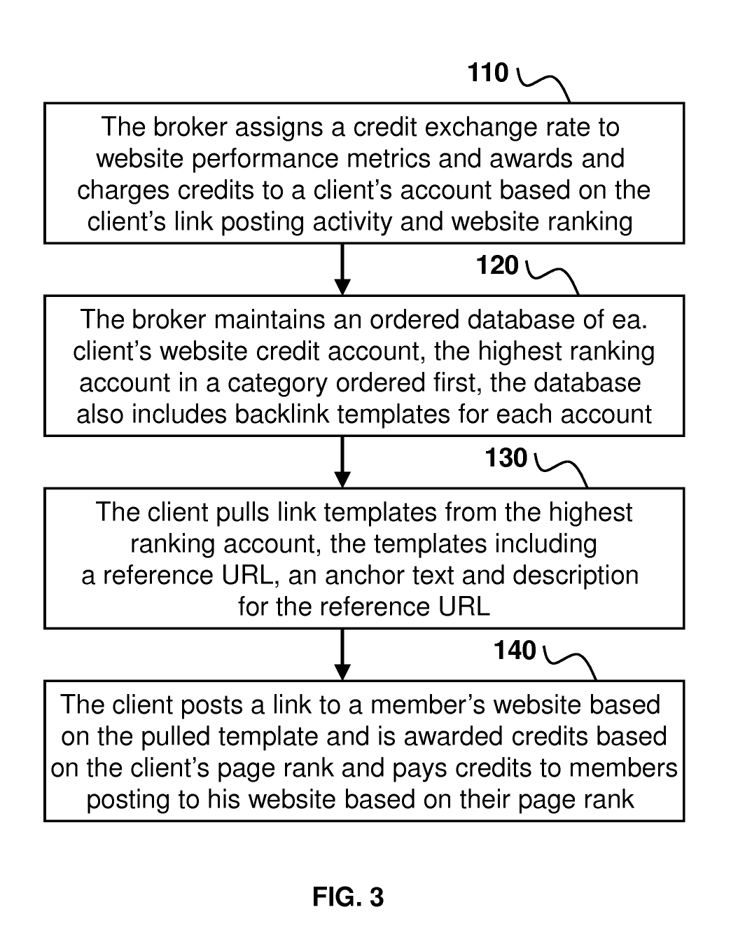

FIG. 3 depicts a flow chart of a method in accordance with an embodiment for improving trade and a client's search engine website rankings to through a membership of clients and a link broker in accordance with an embodiment of the present disclosure. The link broker is optional in embodiments of the disclosed method. The method includes the broker assigning 110 a credit exchange rate to website performance metrics. A performance metric may include a website's search engine ranking. Step 110 also includes the broker awarding and charging backlink credits to a member's website account based on a client's backlink posting activity and the client's website ranking. The link account decouples trading partners from webmasters and allows for the disclosed ‘exchange rate’. It also makes it possible to deliver one-way links exclusively. Step 120 of the disclosed embodiment, further includes the broker maintaining an ordered database of each member's website backlink credit accounts with the highest account in a category ordered most significantly. The client chooses categories and sub-categories in MONOPOLINKS™ most applicable to his website. The database further includes backlink templates for each account. Step 130 includes the client pulling a highest qualifying backlink template from the broker, the template comprising a desired reference (destination) URL, a desired anchor text to be associated with the link, and a description. The client posts a link 140 to a member's website based on the highest qualifying link template in a category. The client pays backlink credits to members posting to his website based on their page rank.

The MONOPOLINKS™ link distribution algorithm may match websites according to their ‘category’ and sub-categories. This feature maximizes the relevance trading sites have to each other and therefore may also increase search engine rankings. The distribution algorithm also prioritizes links according to each website's account credit balance. Because the distribution algorithm distributes links fairly amongst all members based on their trading performance, it inspires confidence in the system and encourages participation. The algorithm also distributes links in a random, ‘non-linear’ fashion due to client trading history and trading relationships making them extremely difficult to trace back to the exchange. Client member data on trading history and trading relationships are saved and tracked in the disclosed system. Randomness is also introduced because it's unknown who will logon to the system and ‘pull’ the next link. The ‘non-linear’ distribution describes the unpredictability of the way links are distributed to one at a time through the disclosed system and the result of the exchange rate's affect on the distribution of links.

The MONOPOLINKS™ SQL based algorithm may match potential link partners based on their common categories or classes in a unique and proprietary taxonomy. It does so by analyzing each partner for both categories and credit balance. The taxonomy includes products, services and leisure. The taxonomy also allows member clients to classify their own websites according to the categories and classes within the taxonomy. A typical taxonomy might have a category called ‘internet marketing’. The disclosed taxonomy may include a product called ‘internet’ and a service called ‘marketing’. The effect of the disclosed method and system is that instead of being grouped with a bunch of ‘internet marketers’, a member may be grouped with ‘internet related businesses’ and ‘marketing related services’, both great potential partnerships! This taxonomy is designed to match a member with ALL related members while limiting the member to ONLY related members.

Embodiments of the disclosed method and system check to be sure the partner has no previous relationship including one as blacklister or blacklistee. When two or more potential partner sites are found the algorithm will deliver the site with the highest credit balance to a client for posting. Although it is possible that a negative credit balance could be the highest qualifying account it is unlikely to occur in practical application. Embodiments of the disclosed system and method allow client member input for changes to existing classes and subclasses in the taxonomy. The system and method also allow for input on additional categories and/or classes within the taxonomy and allow a client to classify his/her website. A member's website may be matched with all related member websites based on classification. A broker or an administrator of the disclosed method and system may modify the taxonomy based on client input concerning existing classes and subclasses or categories and sub-categories or based on input concerning additional classes/subclasses or categories/sub-categories.

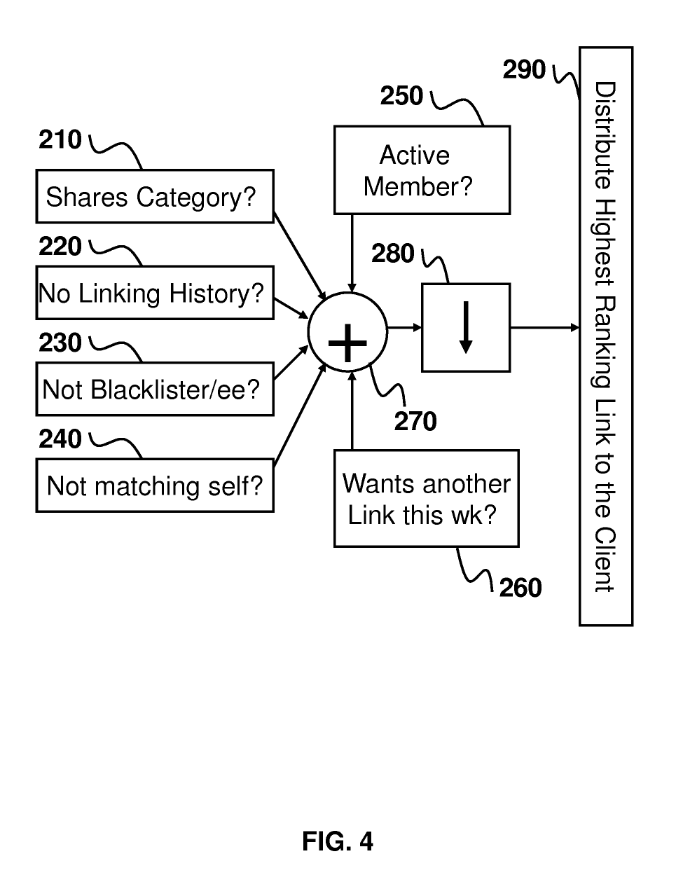

FIG. 4 depicts an ordering algorithm which provides the highest qualifying backlink template to the client in accordance with an embodiment of the present disclosure. The algorithm performs a logical ‘AND’ function of the result of several queries of the broker's backlink template database. Query 210 to determines if another member shares a matching category with the client. Query 220 determines if that matching member already has a link with the client. Query 230 determines if the matching member is a blacklister or a blacklistee of the client. Query 240 assures that the matching member is not the client himself. Query 250 determines if the matching member is an active member of the MONOPOLINKS™ group. Query 260 determines if the client has reached his/her maximum number of desired links (backlinked by other clients) for a given week or another period of time. Module 270 is the logical AND of all the preceding queries and returns a logical positive value for the event that all queries also return logical positive values. Module 280 is an ordering module which orders templates with the highest credit value first in descending order for each website. Step 290 is a distribution of the highest link to the client who clicks on the button to post another link.

An embodiment of the disclosed algorithm may be written in the SQL programming language and/or other languages of the broker's choosing. Other embodiments may implement the disclosed algorithm in various programming languages without changing the basic ideas in the steps above. The following is one embodiment of the disclosed algorithm in the SQL programming language:

select backlink.id as backlinkid
from backlink, website
where websiteid in
(Select distinct(websiteid) from websitecategory where categoryid in
(Select categoryid from websitecategory where websiteid =“.$websiteid.” ))
and websiteid not in(select linktoid from links where linkfromid =“.$websiteid.”)
and websiteid not in (select linkfromid from links where linktoid =“.$websiteid.”)
and websiteid not in (select blacklistee from blacklist where blacklister =
“.$websiteid.”)
and websiteid not in (select blacklister from blacklist where blacklistee =
“.$websiteid.”)
and websiteid< >“.$websiteid.”
and status=‘a’
and backlink.websiteid = website.id
and backlink.active = 1
and linkbal > 0
order by creditbal desc
limit 0,″.$numlinks

Therefore the MONOPOLINKS™ system is a value based link exchange. Realizing that not all websites are created equal, MONOPOLINKS™ rewards higher ranked sites with multiple backlinks from lower ranked sites. This is accomplished by using a link exchange rate which is tied to some measurable quality such as Page Rank or Alexa Ranking.

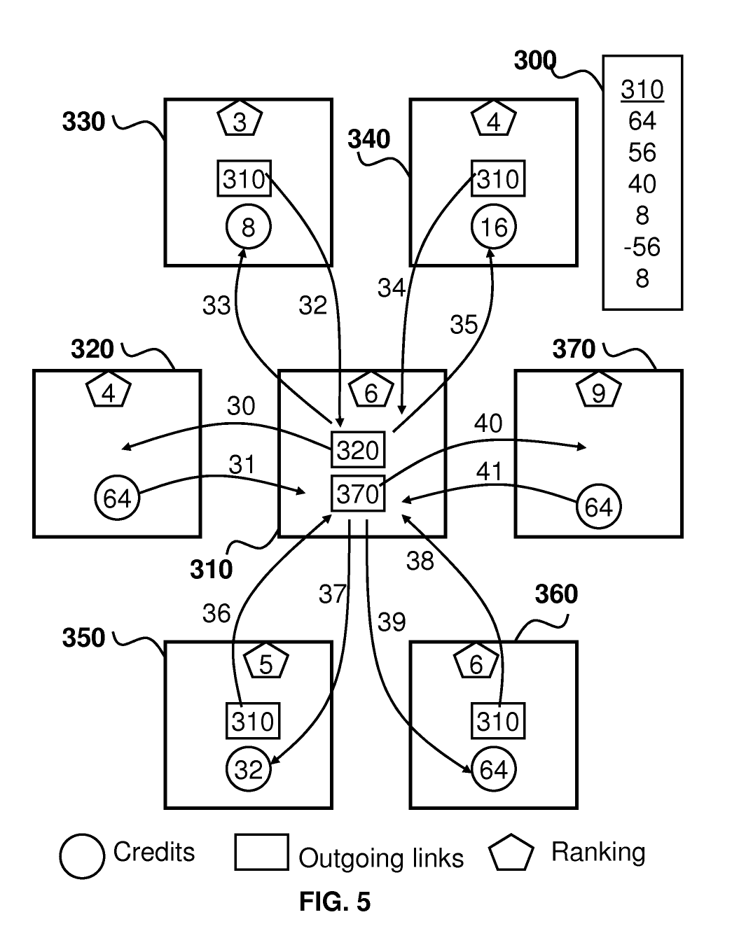

FIG. 5 depicts link trading between a page rank 6 website client and 6 other member websites of various page ranks in accordance with an embodiment of the present disclosure. All transactions between the client and members are facilitated by an embodiment of the disclosed method and system. The first client has an account balance 300 for website 310 with a Google Page Rank of 6. The account balance 300 shows the cumulative credit balance for website 310 after each of the transactions with the six other members as follows. Another member client has website 320 with a GPR of 4. In transaction 30, the first client posts a link on his/her website 310 backlinking to website 320. In transaction 31, website 320 pays 64 credits to the 310 website for the backlink based on the client's page rank of 6. Having earned 64 credits for the posting, website 310 now has a credit account balance of 64 as shown in the first entry of the account balance 300. Transaction 32 is a post from another member's website 330 of a backlink to website 310. Accordingly, transaction 33 is payment of 8 credits to website 330 for the backlink based on a page rank of 3 for website 330. Website 310 now has an account balance of 56 credits.

Transactions 34 and 35 thus occur between website 310 and website 340 for another backlink to website 310 and a payment of 16 credits from 310 website's account into 340 website's account. The 16 credits are paid to website 340 based on a page rank of 4 of the posting website 340. The account balance 300 for website 310 now is 40 credits. Transactions 36, 37 and 38, 39 occur in like manner to create backlinks from website 350 and website 360 respectively with 310 website's account paying 350 website and 360 website's accounts 32 credits and 64 credits based on their respective page ranks of 5 and 6. Therefore, the account balance 300 for website 310 moved through 8 credits and is now at negative 56 credits. At this point, website 310 may continue to trade even though it has a negative balance. The client posting a backlink to website 370 in transaction 40 earns the client an additional 64 credits in transaction 41 based on his page rank of 6. The client's website 310 now has 8 credits in his credit balance 300.

The MONOPOLINKS™ algorithm makes sure new trading partners are previously unrelated thus creating one-way links. So while a GPR6 site may be reluctant to trade links one for one with a PR4 website outside of MONOPOLINKS™, it is more than happy to trade 1 for 4 within the disclosed system.

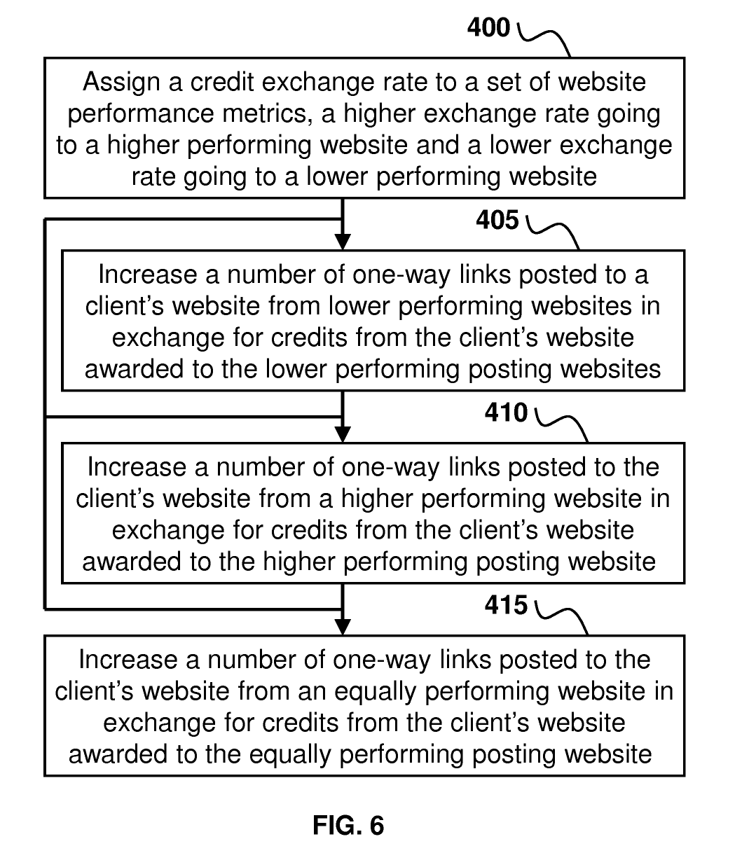

FIG. 6 depicts a flow chart of a computer program product for improving a client's search engine rankings through a member exchange platform in accordance with an embodiment of the present disclosure. The operations of the computer program product include assigning 400 a credit exchange rate to a set of website performance metrics, a higher exchange rate going to a higher performing website and a lower exchange rate going to a lower performing website. The operations of the computer program product also include increasing 405 a number of one-way links posted to a client's website from a plurality of lower performing websites in exchange for credits from the client's website awarded to the lower performing posting websites. The operations of the computer program product additionally include increasing 410 a number of one-way links posted to the client's website from a higher performing website in exchange for credits from the client's website awarded to the higher performing posting website. Furthermore, the operations of the computer program product include increasing 415 a number of one-way links posted to the client's website from an equally performing website in exchange for credits from the client's website awarded to the equally performing posting website. Flow chart step interconnect lines allow operation to proceed from step 400 directly to step 405, step 410, or step 415 without passing through an intermediate step. Therefore, not all steps are required in the depicted method though at least step 400 and one other step are usually performed in a to trading exchange to improve a trader's ranking.

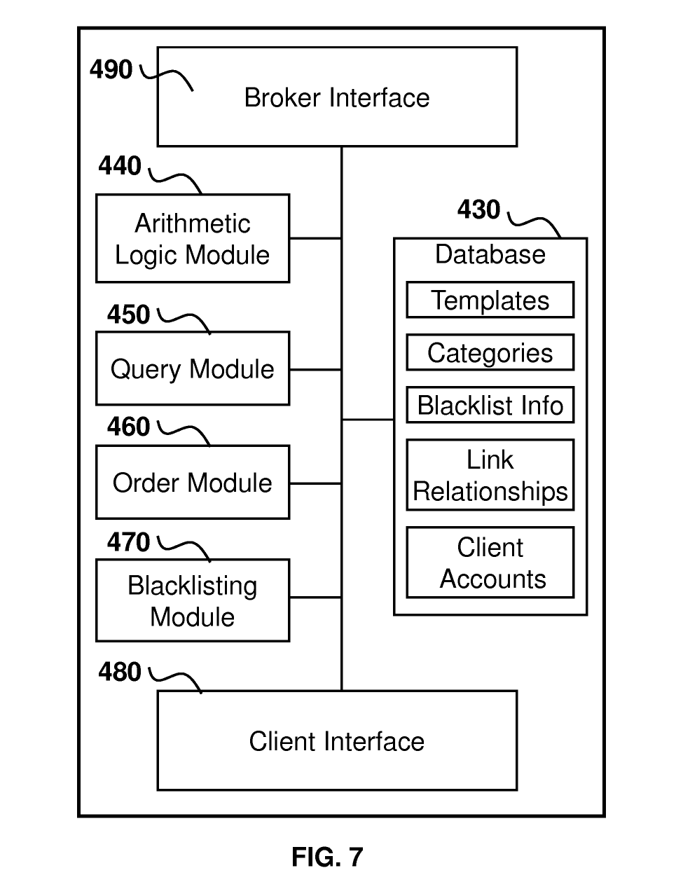

FIG. 7 depicts a block diagram of the system for improving search engine rankings in accordance with an embodiment of the present disclosure. The disclosed client membership and link broker system is configured to promote a higher GPR which may improve a client's search engine website rankings. The system includes the client accounts database 430, the arithmetic logic module 440, the query logic module 450, order module 460, blacklisting module 470 and the client interface 480 and broker interface 490. All modules, interfaces and parts of the system may communicate with each and every other part of the system as shown by interconnecting lines.

The clients' account database 430 depicted in FIG. 7 is configured to store client accounts, backlink templates, categories and sub-categories associated with the website, blacklist information, and link relationships as required by the system automation and the broker. The client accounts are configured to keep a client's website account balance depending on the client's website ranking and the client's link trading activity.

The arithmetic logic module 440 of FIG. 7 is configured to calculate a net credit balance from credits awarded to the client for posting backlinks to other clients' websites and from credits charged from the client when another client posts to the client's website. The arithmetic logic module is therefore configured to award and debit credits based on the posting client's website ranking.

Also depicted in FIG. 7, the query logic module 450 is configured to query the database 430 on whether the client shares a category/subcategory with another client, whether the client is an active link trader, whether the client wants another link per a specified time period and whether the client has blacklisted the particular link to be distributed. The query logic module 450 may also be configured to perform some logic functions on the resulting queries.

The order module 460 of FIG. 7 is configured to list accounts and backlinks within a category in descending order. In other words, the order module 460 may be configured to order a matching partner's backlink template for a destination website with a highest net credit balance higher than a backlink template for a destination website with a lower credit balance. Link relationships to between members may be stored and recalled for use in the query logic and ordering algorithm.

Returning to FIG. 7, the blacklisting module 470 is configured to store URL addresses of blacklisters and blacklistees as chosen by clients and explained further below in the ‘Blacklist Manager’ section. The client interface 480 between a client's computer screen and the system through a network such as the internet, is configured to convey a client's net link value and link information from the broker to the client. The broker interface 490 between a broker's computer screen and the system through a network such as the internet, is configured to allow the broker to set exchange rates for backlink credits and configured to allow the broker to manage the client accounts database 430. In embodiments of the present disclosure, the broker may set up the system to fully automate link trading transactions between member clients.

Home page sign up, sign in. New visitors can use the ‘sign up’ form to initiate the sign up process. A visitor may click the ‘Create Your Free Account’ button and enter his/her website URL but this is optional. Existing members use the ‘Sign In’ form to access their link trading accounts. The signup screen includes fields for the visitor to enter his/her website information and contact details. Once the visitor presses ‘save,’ he/she is taken to a screen stating that they must activate their account to verify their email is valid and prevent automated sign ups by robots and spiders. The visitor may then check his/her email for a welcome message from the MONOPOLINKS™ administrator. Once the visitor opens the message and clicks the link, he/she is ‘validated’ and ‘activated’ as a full member of Monopolinks.com™!

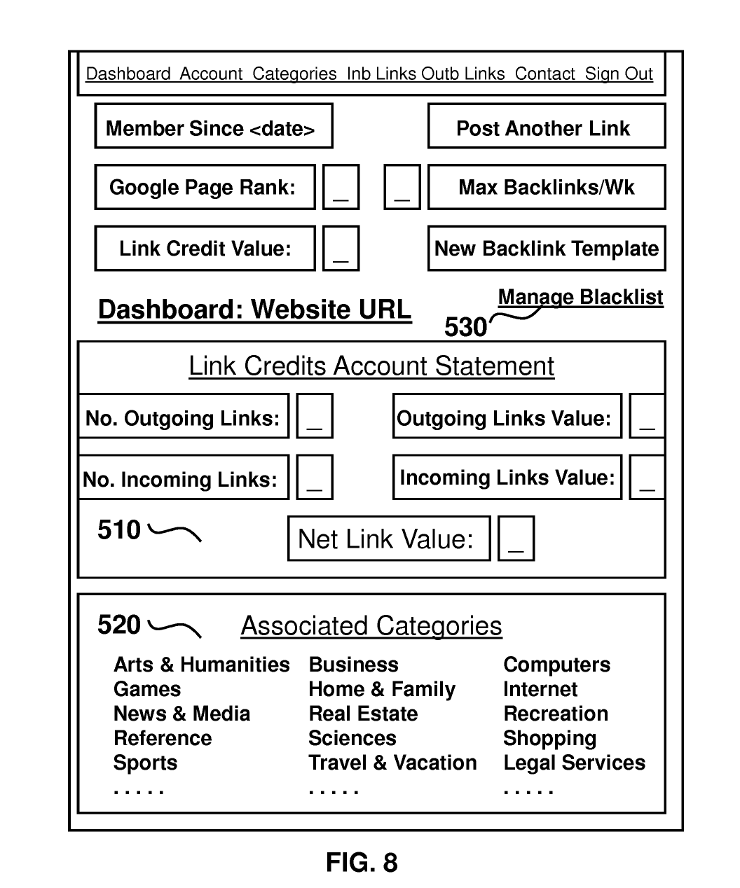

MONOPLINKS™ Dashboard. After logging into his/her account, the client may be taken to the MONOPOLINKS™ account dashboard. FIG. 8 depicts an account dashboard of a disclosed computer screen. The client may use the account dashboard to get an overview of his/her link activity and initiate new activities and to navigate to others system screens. The sub-screen labeled ‘Link Credits Account Statement’ 510 shows the client his/her net link value useable for trading links incoming or outgoing. An incoming link is one posted by another client and an outgoing link is one posted by the client. The number of outgoing links multiplied by the credit value of the website metric may give the outgoing to links' value where the metric may be a GPR or Alexa rank or any other metric. The number of incoming links multiplied by the posting website's GPR may give the incoming links value. The sum of the outgoing links value and the incoming links value yields the net link value. A client having a negative value may still trade links on MONOPOLINKS™.

The sub-screen labeled ‘Associated Categories’ 520 shows the client which categories he/she has chosen to be associated with the website listed ‘Website URL.’ Possible categories include Arts and Humanities, Games, News and Media, Reference, Sports, Business, Home and Family, Real Estate, Sciences, Travel and Vacation, Computers, Internet, Recreation, Shopping, Legal Services, and other categories as submitted by clients and approved by the Broker. There are also possible sub-categories listed within each of the categories above.

The ‘Manage Blacklist’ link 530 allows the client to manage a list of websites with which he/she does not want to trade links. Embodiments of the present disclosure include steps to prevent a blacklisted website from trading links with the client. The disclosed algorithm also prevents blacklisted website backlink templates from being pulled by the client.

There are three tasks a client may perform to get his/her account fully set up. First, the client may associate his/her website with applicable categories and sub-categories. Second, the client may create at least one backlink template, and third, the client may ‘Post Another Link’ to build account credits. Given that the client has performed these three steps, other clients may post backlinks to his website and his/her link trading activity may continue without anymore intervention on his/her part. However, active trading participation by the client may increase his number of incoming links and therefore raise his/her net link value.

Categories. By associating his/her website with applicable categories and sub-categories, also known as classes and sub-classes, the MONOPOLINKS™ algorithm can match a client with link partners who share similar content and themes. This is an important part of link popularity search engine optimization because Google will discount any partners that are unrelated. Clicking on a main category will take the client to a list of sub-categories within a category. The client may select all the sub-categories that apply to his/her website. The more sub-categories a client selects, the higher the chances are he/she will be matched with a link trading partner. On the other hand, clients should avoid selecting irrelevant sub-categories because non-relevant linking partners will not help their page rank and could possibly even damage their website's reputation with Google.

Sub Categories. Selecting a category is one step in an embodiment to tell the system what type of websites the client would like to be linked with. The client may also select appropriate sub-categories within a selected category. For example, sub-categories within the ‘Money and Finance’ category include banking, blogs on money and finance, bonds, credit and debt, currency, Forex trading, fundraising, insurance, merchant accounts, planning and accounting, precious metals, securities and investing, and the stock market. Clients may propose new sub-categories to the broker for inclusion into the system at any time. The broker, at his discretion, may choose whether to allow or not allow a proposed sub-category. A disclaimer notice may be displayed on sub-categories screens to the effect that selecting all sub-categories relating to the topic of the client's website maximizes trading partners but selecting unrelated topics may also hurt the client's search engine rankings.

In-bound links. The second thing a client may do to get his/her MONOPOLINKS™ one-way link trading account setup is to create at least one backlink template. This template is what the system will distribute to other webmasters to post on their websites. The client creates a new backlink template by going to the ‘Inbound Links’ screen and pressing the ‘New Backlink Template’ button. Once a client creates a backlink template it will show in a list with the rest of the client's templates. The client should create more backlink templates over time to vary his/her anchor text distribution. Having different sites post different link templates will make the client's campaign look more natural rather than having every link read the same thing. The numbers under a ‘Links’ heading on the inbound links screen may show how many webmasters have used a specific template to link back to the client's site. A client may click the number to see a list of URL's where that template is posted.

A client may also use the inbound links screen to control how prolific the client's link is within the system. The ‘No more than X backlinks per to week’ setting will throttle the client's link distribution to X backlinks. X is a number input by the client on the screen. Leaving this setting at 10 and then increasing it slowly over a period of weeks will simulate a natural link accumulation. If the client gets too many backlinks too fast, Google may think the client is purchasing links or gaining them in some other unnatural fashion. However, it is a feature of the present disclosure that the client is allowed to control this backlinks distribution variable though a default setting may be chosen by the broker.

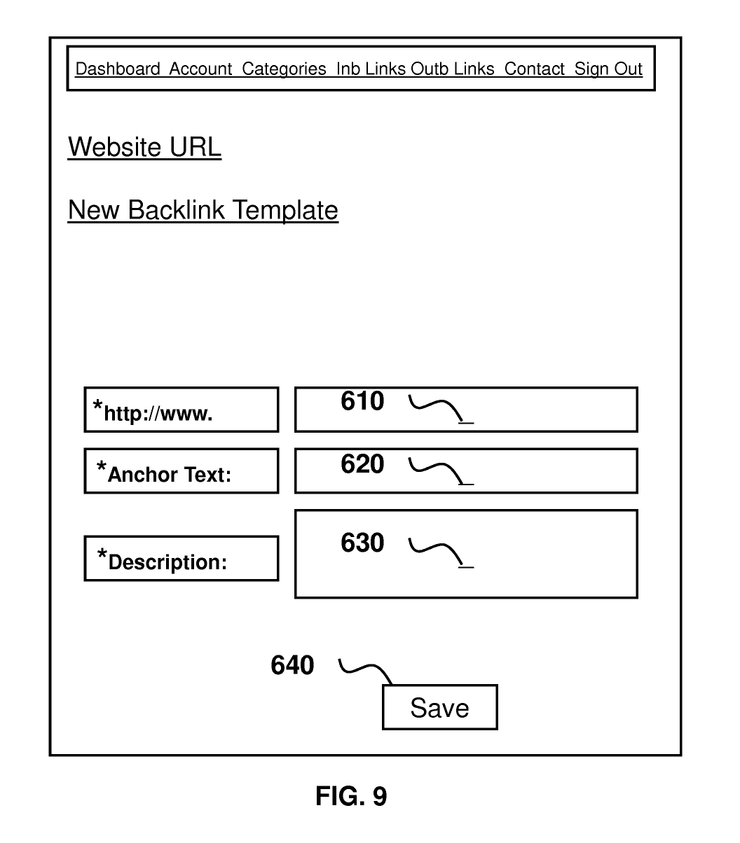

New Backlink Template. After clicking the ‘New Backlink Template’ button on the ‘Incoming Links’ screen, the client is taken to ‘New Backlink Template’ screen where he/she can enter backlink details. FIG. 9 depicts a client's ‘New Backlink Template’ computer screen in accordance with an embodiment of the present disclosure. The screen includes the URL the client would like to have referenced 610 (his website URL), the anchor text the client wants associated with the link 620 (blue underlined text on the poster's website) and a short description of the link 630 (no blueline). The client may press the ‘save’ button 640 once he/she has entered information into the available fields. The ‘save’ action saves the information as a backlink template and returns the client to the ‘Incoming Links’ screen where the client may see the new template on the template list.

Backlink Report. Clicking one of the numerical links in the ‘Links’ column of the Backlink Template List' on the ‘Incoming Links’ screen may take the client to a list of websites using that backlink template to link back to the client's website. This backlink report list may also include the ranking and the exchange rate value for each website using the client's backlink and the date the link was posted. Additionally, the common categories the client and the other member share may be viewed by clicking on the ‘common categories’ link. The client may click the different links in the report to view the page that links back, view the categories common to the site or even blacklist the linking partner. Blacklisting a link partner will cause him/her to remove the client's link and will prevent further links between the client and blacklisted partner's sites in the future. The client may ‘unblacklist’ a partner at any time.

Outbound Links. The ‘outbound links’ screen shows all the partners to that a client is linking out to from his/her website and the date the link was posted. The client may click on the partner URL to be taken to the page posting the client's backlink. Alternatively, the client may click the ‘edit’ link (not depicted) to change the page from which he/she is linking to another member's website. The client may also blacklist the partner by clicking the blacklist button.

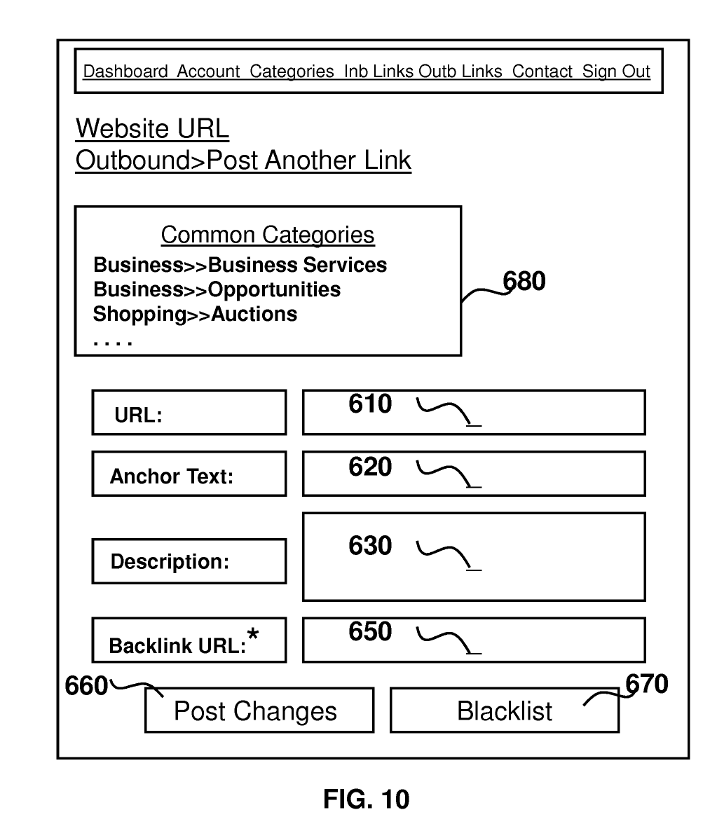

Edit Link. By clicking the ‘edit’ link next to a link partner on the ‘outgoing links’ screen (not depicted), the client may be taken to the ‘edit link’ screen. FIG. 10 depicts a client's ‘Outbound, Post Another Link’ computer screen in accordance with an embodiment of the present disclosure. This is the same screen the client would see to post a new link or to edit an outbound link. The client may change the URL 650 from which he/she posted the link (source website URL for the link) by making changes and pressing the ‘Post Changes’ button 660. The client may also blacklist the partner here by pressing the ‘Blacklist’ button 670. Pressing button 670 will reverse any credits earned for making the post so the client should remove the respective backlink from his/her website after blacklisting. The ‘Common Categories’ field lists the categories the client has in common with the trading partner listed in the URL field 610.

Post Another Link. The ‘Post Another Link’ screen is where the client may be taken when pressing the ‘Post Another Link’ button from the ‘dashboard’ or ‘outbound links’ screens. This screen contains the information a client needs to post to another client's website to earn credits. The client uses the data to construct a link and post it to another client's site. Once posted, the client may click the ‘Post Changes’ button. The automated MONOPOLINKS™ link checker may validate that the client has posted the link and return the client to the ‘incoming links’ screen. If the client decides that the partner is not a good match, the client may press the ‘Blacklist’ button to prevent that client from showing up on his/her list of links to be posted again.

Blacklist Manager. The client may use the ‘Blacklist Manager’ to manage partners on his/her blacklist. The client may blacklist any partner with which whom he/she does not wish to be associated in link trading. By blacklisting a website it will disassociate or block the client from any incoming or outgoing links, reverse the credits and prevent the partner from showing up when the client posts another link. Blacklisting a partner will therefore prevent the client from to showing up on the blacklistee's list. A client may also ‘un-blacklist’ a partner at any time.

The broker may be a mediator between a client and another member client and may therefore be an intermediary, putting together buyers and sellers of website links. The broker may also market and explain the MONOPOLINKS™ products to members and non-members alike. Additionally, though the broker may or may not trade links directly, the broker acts as an agent between clients and may therefore charge a commission for services. Therefore the term ‘broker’ may refer to the combination of a person and computer automation or the term ‘broker’ may also refer to a fully automated process.

MONOPOLINKS™ is a new and unique system for getting one-way backlinks to a client's website. Built on principles of fairness, the platform introduces new concepts and business volume to the link trading industry. The built in exchange rate promotes a prolific trading environment while the integrated trading platform and MONOPOLINKS™ SQL based algorithm automates much of the mundane tasks normally associated with link trading. Embodiments include automation enhancements to streamline a client's posting links to his own websites.

Other embodiments may include a system generated HTML for a single link or a list of links or even a whole link directory structure. Also, an input host account userid and password and system to upload files to a client's server may be included. Embodiments may upload PHP files to a user's host which taps the database for users' links where a PHP file is a file constructed using the programming language PHP. Still further embodiments may include ‘server side’scripting languages that allow for the dynamic creation of web pages as well as HTML embodiments which are static. In effect, the PHP file on the client's host queries the broker's database and displays the client links automatically.

Disclosed embodiments may also include backend processes which run periodically and are managed by the broker. One such backend process checks all member sites for missing links and emails a warning to the member when one is found. If a member receives 2 warnings and the problem still exists, the process removes the link from the system and reverses the credit transactions for both the linker and linkee.

Another embodied backend process runs weekly and summarizes each member account. The process may email the member numbers showing how many links were traded in his/her account in the last week. The email may also include the total number of links in and out of the client's account as well as respective periodic balances for inbound and outbound links. The process may also email inactive clients to remind them to become more active and trade links with other client members. In addition, weekly routine processes may reset the links per week counter and verify each account balance for accuracy.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated but by the claims and their equivalents herein.

What is claimed is:

1. A method for improving trading in a member exchange platform, the method comprising:
assigning a performance based exchange rate to each member client based on at least one predetermined platform performance metric;
awarding a credit to a first member client for placing a trade to a second member client, the credit based on the first member client exchange rate; and
charging the credit to the second member client in exchange for the trade.

2. The method for improving trade of claim 1, wherein the first member client placing a trade to a second member client comprises the first member client placing a one-way link on a webpage of the first member client pointing to a webpage of the second member client in exchange for a credit from the second member client.

3. The method for improving trade of claim 1, further comprising:
assigning a performance based exchange rate to each member website based on at least one predetermined platform performance metric;
awarding a credit to a first member website for posting a one-way link to a second member website, the credit based on the first member website exchange rate; and
charging the credit to the second member website in exchange for the one-way link.

4. The method for improving trade of claim 3, further comprising:
tracking member data, the member data comprising a link trading history of link trading relationships;
selecting a plurality of members based on the member data; and
distributing automatically a plurality of one-way link addresses to the selected members.

5. The method for improving trade of claim 4, wherein tracking member data further comprises determining whether the client is an active link trader, whether the client wants another link per a specified time period, and whether the client has blacklisted the particular link to be distributed.

6. The method for improving trade of claim 4, further comprising:
prioritizing a matching partner's backlink template for a destination website with a highest net credit balance higher than a backlink template for a destination website with a lower credit balance; and
distributing a highest prioritized backlink template to a client pulling a backlink for posting, the distributing based on the client's link trading performance.

7. The method for improving trade of claim 4, wherein distributing automatically one-way link addresses to selected members based on member data further comprises randomly distributing one-way link addresses based on the member link trading history of link trading relationships.

8. The method for improving trade of claim 3, further comprising:
generating a taxonomy of classes comprising a plurality of products, services and leisure, the classes available for a client to classify his/her website;
classifying a member website into one and/or multiple taxonomy classifications;
matching a member website with all related member websites based on the classification.

9. The method for improving trade of claim 8, wherein the class and the sub-class available for the client to choose may be modified by discretion of a broker based on client input concerning existing classes and sub-classes and based on client input for additional categories and sub-categories.

10. The method for improving trade of claim 3, further comprising each client providing at least one backlink template comprising a desired destination website URL (Uniform Resource Locator), a desired anchor text to be associated with the destination URL, and a description of the destination URL.

11. The method for improving trade of claim 3, the method further comprising:
the first client pulling a second client's backlink template; and
the first client posting an outgoing link to the second client's website based on the destination website URL in the pulled link template.

12. The method for improving trade of claim 3, further comprising blacklisting any client at any time by:
blocking the client from any incoming and/or outgoing links;
reversing any credits exchanged in prior postings; and
preventing the blacklisted client from showing up when the client posts another link.

13. The method for improving trade of claim 10, further comprising limiting a number of times a client's destination URL may be backlinked by other clients during a period of time based on a maximum number determined by the client.

14. A computer program product comprising a computer readable medium having computer useable code executable to perform operations for improving a client's search engine rankings through a member exchange platform, the operations of the computer program product comprising:
assigning a credit exchange rate to a set of website performance metrics, a higher credit exchange rate going to a higher performing website and a lower credit exchange rate going to a lower performing website;
increasing a number of one-way links posted to the client's website from a plurality of lower performing websites in exchange for credits from the client's website awarded to the lower performing posting websites; and
increasing a number of one-way links posted to the client's website from a higher performing website in exchange for credits from the client's website awarded to the higher performing posting website.

15. The computer program product of claim 14, further comprising increasing a number of one-way links posted to the client's website from an equally performing website in exchange for credits from the client's website awarded to the equally performing posting website.

16. A system configured to improve trading and ranking, the system comprising:
a client accounts database comprising at least one back-link template and a net credit balance for at least one website for the client and for a plurality of other clients, the database also comprising a blacklist of other clients as specified by the client and a category and a subcategory selected by each client from a list provided from a broker;
an arithmetic logic module configured to calculate a net credit balance from credits awarded to the client for posting backlinks to other clients' websites and from credits charged from the client when another client posts to the clients' website, the arithmetic logic module configured to award and debit credits based on the posting client's website ranking;
a query logic module configured to query the database on whether the client shares a category/subcategory with another client, whether the client is an active link trader, whether the client wants another link per a specified time period, and whether the client has blacklisted the particular link to be distributed, the query logic module also configured to perform logic functions on the resulting queries;
a ordering module configured to order a matching partner's backlink template for a destination website with a highest net credit balance higher than a backlink template for a destination website with a lower credit balance;
a client interface on the internet configured to receive information from a client and to convey information to the client from the system and from the broker; and
a broker interface on the internet configured to allow the broker to set exchange rates for backlink credits and configured to allow the broker to otherwise manage the system.

17. The system configured to improve a client's website search engine ranking of claim 16, further comprising a backlink report listing websites using a client's backlink template to link back to the client's website and listing the ranking and exchange rate for each website using the client's backlink and the date the backlink was posted.

18. The system configured to improve a client's website search engine ranking of claim 16, further comprising a link checker configured to validate that a client has posted a link to a pulled backlink template.

19. The system configured to improve a client's website search engine ranking to of claim 16, further comprising a backend process configured to summarize each client account including a total number of links in and out of a client's account and periodic balances for inbound and outbound links.

20. The system configured to improve a client's website search engine ranking of claim 16, further comprising at least one display configured to show the client's website rank, maximum backlinks per week, number of outgoing links, number of incoming links, outgoing links value, incoming links value, net link balance, and selected categories and sub-categories.
